(19) United States
(12) Patent Application Publication
(10) Pub. No.: US 2008/0173519 A1
(43) Pub. Date: Jul. 24, 2008

(54) CENTRALIZING CONVEYER ASSEMBLY AND METHOD OF CENTRALIZING A CONVEYED PRODUCT

(75) Inventor: Allen Ely, Downingtown, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: PACKAGING PROGRESSIONS, INC., Collegeville, PA (US)

(21) Appl. No.: 11/970,788

(22) Filed: Jan. 8, 2008

Related U.S. Application Data
(60) Provisional application No. 60/897,197, filed on Jan. 24, 2007.

(51) Int. Cl. B65G 47/22; B65G 47/00

(52) U.S. Cl. 198/456; 198/502.3; 198/617

(57) ABSTRACT

A centralizing conveyor assembly for establishing and/or maintaining a centered or aligned position of a product on the conveyor assembly is provided. The centralized conveyor assembly includes a main conveyor, preferably in communication with an interleaver assembly located downstream, and a laterally adjustable infeed conveyor located upstream. The laterally adjustable infeed conveyor is slidably connected to the main conveyor. An actuator laterally moves the laterally adjustable infeed conveyor, thereby aligning the product with respect to a centered or aligned position on the main conveyor as the product is conveyed from the laterally adjustable infeed conveyor downstream to the main conveyor. This results in centered or aligned product being delivered to the interleaver assembly.

### BACKGROUND

The use of automated conveyors is widespread in a variety of industries. It is often important to ensure that a product being conveyed remains centered on a conveyor belt. For example, in the food industry, more specifically in the field of sliced food such as bacon, due to the varying conditions of the bacon (i.e., hardness, temperature, etc.), the sliced bacon may fall at different locations on the conveyor that carries it away from the blade. For bacon that is interleaved on sheets of paper, such variations in positioning can cause portions of the bacon slices to overhang the edges of the paper after interleaving. This overhang is not only aesthetically unattractive, but in the case of an automatic stacking device, can cause improper stacking.

Accordingly, there remains a need for a centralizer for establishing and/or maintaining a centered position of a product on a conveyor.

### SUMMARY

The present invention provides a centralizing conveyor assembly for establishing and/or maintaining a centered position of a product on the conveyor assembly. The centralizing conveyor assembly includes a main conveyor and a laterally adjustable infeed conveyor. The main conveyor includes a laterally fixed intermediate roller positioned downstream from the laterally adjustable infeed conveyor. The laterally adjustable infeed conveyor includes a laterally adjustable roller and an infeed roller. A first plurality of parallel conveying bands is disposed around the laterally adjustable roller and the infeed roller. A second plurality of parallel conveying bands is disposed around the laterally fixed intermediate roller and the laterally adjustable roller. The first plurality of parallel conveying bands alternate along a length of the laterally adjustable roller with each of the second plurality of parallel conveying bands. A pair of opposing sensors are mounted on opposite lateral sides of the laterally adjustable infeed conveyor to detect misalignment of the product on the laterally adjustable infeed conveyor with respect to a centerline of the main conveyor. A controller receives signals from the sensors and communicates with an actuator that laterally moves of the laterally adjustable infeed conveyor in response to signals received from the controller, thereby aligning the product with respect to the centerline of the main conveyor as the product is conveyed from the laterally adjustable infeed conveyor downstream to the main conveyor portion of the conveyor assembly.

An interleaver assembly is preferably provided in combination with the centralizing conveyor assembly to create a centralizing interleaver. The interleaver assembly is centrally aligned with the centerline of the main conveyor. Product fed down the centralizing conveyor assembly is interleaved onto a substrate as it exits the conveyor assembly. The sensors are set at or near a width of the substrate so that product carried by the centralizing conveyor is positioned so that it is deposited by the centralizing conveyor onto the substrate without overhanging the sides of the substrate.

The present invention also provides methods of centralizing a product for conveyance along a conveyor assembly. A laterally adjustable infeed conveyor centers product with respect to a longitudinal centerline of the main conveyor assembly. The product is fed on the laterally adjustable infeed conveyor, and misalignment of the product with respect to the centerline is detected using sensors. Signals are sent from the sensors to a controller, which signals an actuator in order to effect a position adjustment of the laterally adjustable infeed conveyor. Lateral movement of the laterally adjustable infeed conveyor is activated in response to the signals received from the controller to align product with respect to the centerline as the product is conveyed from the laterally adjustable infeed conveyor to a main conveyor of the conveyor assembly.

### BRIEF DESCRIPTION OF THE DRAWING(S)

FIG. 1 is a plan view of a centralizing conveyor assembly in accordance with the present invention; and

FIG. 2 is a side view of the centralizing conveyor assembly of FIG. 1.

### DETAILED DESCRIPTION OF THE PREFERRED EMBODIMENT

Certain terminology is used in the following description for convenience only and is not considered limiting. Words such as “front,” “back,” “top,” and “bottom” designate directions in the drawings to which reference is made. This terminology includes the words specifically noted above, derivatives thereof, and words of similar import. Additionally, the terms “a” and “one” are defined as including one or more of the referenced item unless specifically noted. The phrase “at least one of” followed by a list of two or more items, such as A, B or C, means any individual one of A, B or C, as well as any combination thereof.

The preferred embodiments of the present invention are described below with reference to the drawing figures where like numerals represent like elements throughout.

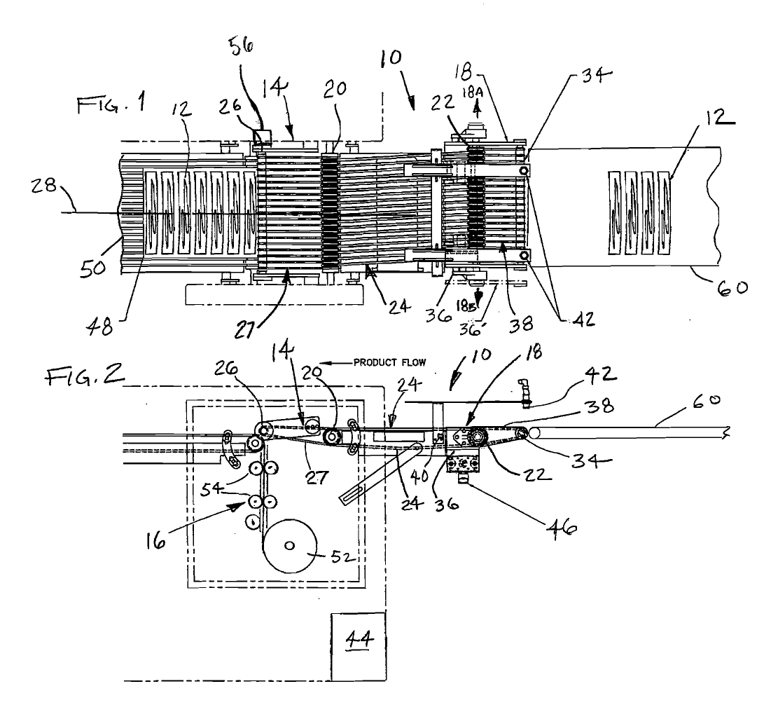

Referring to FIGS. 1 and 2, a centralizing conveyor assembly 10 is shown for establishing and/or maintaining a centered position of a product or group of products 12 such as sliced bacon on the conveyor assembly 10. The centralized conveyor assembly 10 includes a main conveyor 14 and a laterally adjustable infeed conveyor 18.

The laterally adjustable infeed conveyor 18 comprises a laterally adjustable roller 22 and an infeed roller 34 positioned upstream from the laterally adjustable roller 22. The infeed roller 34 is connected to the laterally adjustable roller 22 via a first plurality of parallel conveying bands 38 which extend in plane(s) parallel to a longitudinal centerline 28 of the main conveyor as the infeed roller 34 moves laterally in conjunction with the laterally adjustable roller 22, this parallel relationship with the centerline 28 is maintained. The infeed roller 34 is mounted together with the laterally adjustable roller 22 on a laterally adjustable carriage assembly 36, such that the infeed rollers 22, 34 are movable together via the carriage 36 for lateral adjustment of the infeed conveyor 18. The laterally adjustable infeed conveyor 18 is movably positioned upstream from the main conveyor 14.

The main conveyor 14 comprises a laterally fixed intermediate roller 20. A second plurality of parallel conveying bands 24 are disposed around the laterally fixed intermediate roller 20 and the laterally adjustable roller 22 of the laterally adjustable infeed conveyor 18. The main conveyor 14 may further comprise a laterally fixed output roller 26 positioned downstream from the laterally fixed intermediate roller 20, and a third plurality of parallel conveying bands 27 disposed around the laterally fixed intermediate roller 20 and the laterally fixed output roller 26.

In FIG. 1, the laterally adjustable infeed conveyor 18 is represented in solid lines in an off-center lateral position with respect to the centerline 28, and in phantom lines in an opposite off-center lateral position indicated by 36′. Because the infeed roller 34 moves laterally in conjunction with the laterally adjustable roller 22, each of the first plurality of parallel conveying bands 38 remains parallel with the longitudinal centerline 28 of the main conveyor 14 regardless of the lateral position of the laterally adjustable infeed conveyor 18. In contrast, because the laterally fixed intermediate roller 20 of the main conveyor 14 does not move laterally in conjunction with the laterally adjustable intermediate roller 22, each of the second plurality of parallel conveying bands 24 extends at an angle with respect to the longitudinal centerline 28 of the main conveyor 14 when the lateral position of the laterally adjustable infeed conveyor 18 is shifted from a centered position. Preferably, all of the rollers 20, 22, 26, 34 include annular grooves that receive respective ones of the bands 24, 27, 38 to maintain the desired spacing between bands.

A proximity sensor 40, shown in FIG. 2 detects alignment to facilitate positioning of the laterally adjustable infeed conveyor 18 with respect to the longitudinal centerline 28 of the main conveyor 14. A pair of opposing photoeye sensors 42 are mounted on opposite lateral sides of the laterally adjustable infeed conveyor 18 to detect misalignment of the product 12 as it passes onto the laterally adjustable infeed conveyor 18 with respect to the centerline 28. While photoeye sensors 42 are preferred, those skilled in the art will recognize that other types of sensors could be utilized.

The position of the laterally adjustable infeed conveyor 18 is controlled by a controller 44, which receives signals from the sensors 42, and transmits control signals to an actuator 46, which can be an electric motor driven linear actuator, a pneumatic actuator, or any other suitable linear drive, which is connected to the carriage assembly 36 to provide lateral movement of the laterally adjustable infeed conveyor 18 in response to signals received from the controller 44. Misaligned product 12 on a feed conveyor 60 is therefore always placed in what will be a centered position on the adjustable infeed conveyor 18 due to its adjusted position. Due to the second plurality of parallel conveying bands 24 being angled from the laterally adjustable roller 22 to the laterally fixed intermediate roller 20, the product 12 is shifted to a centered position. The product 12 is thereby aligned with respect to the centerline 28 of the main conveyor 14 as the product 12 is conveyed on the second plurality of bands 24 from the laterally adjustable infeed conveyor 18 downstream to the main conveyor 14 of the conveyor assembly 10.

The controllers 44 can be a PLC or other type of controller, or can be implemented as software in a computer controller for the conveyor assembly.

In use, the proximity sensor 40 assists in adjusting the position of the laterally adjustable infeed conveyor 18 with respect to the centerline 28. Product 12, such as the illustrated sliced bacon, is fed from a slicer (not shown) onto a feed conveyor 60 to the laterally adjustable infeed conveyor 18 as a group. If the sensors 42 do not detect that the bacon 12 is misaligned on the laterally adjustable infeed conveyor 18 with respect to the centerline 28, (for example, due to the photoeye sensors 42 not being blocked by the product 12), the laterally adjustable infeed conveyor 18 remains centered and makes no corrections to the alignment of the bacon 12. If, however, the sensors 42 detect misalignment of the bacon 12 (due to blockage of the left or right sensor 42 by the product 12 on the laterally adjustable infeed conveyor 18 with respect to the centerline 28), the controller 44 counts the number of misaligned products detected.

When a predetermined number of activations are detected by one of the two sensors 42, for example 10 activations, indicating a bias of the product 12 coming from the feed conveyor 60, the controller 44 sends a signal to the actuator 46 in order to correct a misalignment of the product 12 with respect to the centerline 28. In response, the actuator 46 activates lateral movement of the carriage assembly 36 to laterally adjust the position of the laterally adjustable infeed conveyor 18 toward the detected bias direction. More specifically, the actuator 46 causes the laterally adjustable roller 22, carried by the adjustable infeed conveyor 18, to move in a lateral direction 18A or 18B with respect to the centerline 28, a predetermined amount, for example 0.25 inches. The second plurality of parallel conveying bands 24 allow this shifting relative to the main conveyor 14 due to their flexibility. This controlled shifting of the laterally adjustable infeed conveyor 18 corrects the misalignment of the product 12 (i.e., centers the product 12) with respect to the centerline 28, or to the extent the bias is still sensed, a further correction is made. The properly aligned product 12 is then conveyed from the laterally adjustable infeed conveyor 18 to the main conveyor portion 14 of the conveyor assembly 10, and then preferably to the interleaver assembly 16.

An interleaver assembly 16 is preferably provided with the centralizing conveyor assembly 10 to form a centralizing interleaver in order to interleave the centered product 12 onto a substrate 48 (e.g., a sheet of paper) as it passes from the laterally fixed output roller 26 onto a product packaging conveyor 50. The interleaver assembly 16 preferably is arranged centered with the common centerline 28 of the main conveyor 14, so that the substrate 48 is centered as it is inserted beneath the product 12 as it transitions from the main conveyor 14 to the packaging conveyor 50. The interleaver assembly 16 preferably feeds the substrate 48 from a main roll 52 through a plurality of perforation and feed rollers 54 to a position between the laterally fixed output roller 26 and the packaging conveyor 50.

A position sensor 56 senses the product as it approaches the packaging conveyor 50 and the controller 44 signals the interleaver 16 to insert the substrate 48 under the product 12 in time with its movement. While a preferred interleaver 16 is shown and briefly described, those skilled in the art will recognize that various types of interleaver assemblies could be utilized.

Each of the first plurality of parallel conveying bands 38 alternate along a length of the laterally adjustable roller 22 between each of the second plurality of parallel conveying bands 24. Similarly, each of the second plurality of parallel conveying bands 24 alternate along a length of the laterally fixed intermediate roller 20 with each of the third plurality of parallel conveying bands 27. Each member of each plurality of parallel conveying bands 24, 27, and 38 is preferably an o-ring belt. The present invention, however, is not limited to the use of o-ring belts, and may include any type of parallel band suitable for performing the above-described functions. Similarly, the number of parallel conveying bands 24, 27, and 38 represented in FIG. 1 is for illustrative purposes only. The present invention may include any number of parallel conveying bands to suit the particular needs of the industrial application.

The actuator 46 may optionally be a rotary motor with an appropriate drive. Alternatively, the actuator 46 may be any other type of motor or actuator capable of performing the above-described functions.

In the preferred embodiment, the now centered product 12 is interleaved on the substrate 48, without hanging sideways off of the substrate 48 and conveyed on the product packaging conveyor 50 for further stacking and/or packaging operations, depending upon the packaging requirements of a particular application.

Seven slices of bacon 12 are represented in FIG. 1. The present invention, however, is not limited to centrally conveying seven slices of bacon 12, and may centrally convey a wide variety and number of products to suit the particular needs of the industrial application. Similarly, the dimensions of the substrate 48 may vary to suit the particular needs of the industrial application.

While the preferred embodiments of the invention have been described in detail above, the invention is not limited to the specific embodiments described which should be considered as merely exemplary. To the extent that the invention is described as aligning product along a “centerline,” those skilled in the art will understand that “centerline,” is intended to refer to any reference line that extends parallel to the direction of travel of the conveyor that can be used as a reference guide for aligning products and interleaving substrate, and is not limited to being physically at the center of the conveying system. Further modifications and extensions of the present invention may be developed and all such modifications are deemed to be within the scope of the present invention as defined by the appended claims.

What is claimed is:

1. A centralizing conveyor assembly for at least one of establishing or maintaining a centered or aligned position of a product on the conveyor assembly, the centralized conveyor assembly comprising:
a main conveyor comprising a laterally fixed intermediate roller and having a longitudinal centerline;
a laterally adjustable infeed conveyor comprising a laterally adjustable roller positioned upstream from the laterally fixed intermediate roller, an infeed roller positioned upstream from the laterally adjustable roller, and a first plurality of parallel conveying bands disposed around the infeed roller and the laterally adjustable roller;
a second plurality of parallel conveying bands disposed around the laterally adjustable roller and the laterally fixed intermediate roller;
a pair of sensors mounted on opposite lateral sides of the laterally adjustable infeed conveyor that detect misalignment of the product at the laterally adjustable infeed conveyor with respect to the centerline of the main conveyor;
a controller that receives signals from the sensors; and
an actuator that laterally moves the laterally adjustable infeed conveyor in response to signals received from the controller, to align the product with respect to the centerline as the product is conveyed from the laterally adjustable infeed conveyor downstream to the main conveyor portion of the conveyor assembly.

2. The centralizing conveyor assembly of claim 1, further comprising a proximity sensor that detects alignment of the laterally adjustable infeed conveyor with respect to the main conveyor.

3. The centralizing conveyor assembly of claim 1, wherein each of the first and second plurality of parallel conveying bands comprise o-ring belts.

4. The centralizing conveyor assembly of claim 1, wherein the main conveyor further comprises:
a laterally fixed output roller positioned downstream from the laterally fixed intermediate roller; and
a third plurality of parallel conveying bands disposed around the laterally fixed intermediate roller and the laterally fixed output roller.

5. The centralizing conveyor assembly of claim 4, wherein each of the first, second and third plurality of parallel conveying bands comprise o-ring belts.

6. The centralizing conveyor assembly of claim 1, wherein the laterally adjustable infeed conveyor further comprises a laterally adjustable carriage assembly, that moves the laterally adjustable roller and the infeed roller together.

7. The centralizing conveyor assembly of claim 1, wherein the pair of sensors comprises a pair of photoeye sensors.

8. The centralizing conveyor assembly of claim 4, further comprising an interleaver assembly that interleaves the product onto a substrate as the product transitions from the laterally fixed output roller to a packaging conveyor.

9. The centralizing conveyor assembly of claim 8, wherein the interleaver assembly comprises:
a main roll;
a plurality of perforation and feed rollers that feed the substrate from the main roll through the plurality of perforation and feed rollers to a position between the laterally fixed output roller and the packaging conveyor in a position to receive the product.

10. A method of centralizing a product conveyed along a conveyor assembly, the method comprising the steps of:
feeding the product on to a laterally adjustable infeed conveyor;
detecting misalignment of the product on the laterally adjustable infeed conveyor with respect to a the conveyor assembly using sensors;
signaling any detected misalignment from the sensors to a controller; and
adjusting a position of the laterally adjustable infeed conveyor to align the product.

11. The method of claim 10, further comprising the step of using a proximity sensor to detect a position of the laterally adjustable infeed conveyor with respect to the conveyor assembly before feeding the product on to the laterally adjustable infeed conveyor.

12. The method of claim 10, further comprising the steps of:
sending signals from the controller to an actuator;
activating lateral movement of the actuator, and adjusting a position of the laterally adjustable infeed conveyor using the actuator in response to the signals received from the controller.

13. The method of claim 12, further comprising the steps of:
aligning a product based on an observed trend of misalignment; and
gradually shifting a position of the product laterally toward an aligned position using a first plurality of conveying bands that extend between a roller on the laterally adjustable infeed conveyor and a roller on a fixed position of the conveyor assembly.

14. The method of claim 13, further comprising the step of interleaving the product onto a substrate.
